(19) United States
(12) Patent Application Publication
(10) Pub. No.: US 2002/0071162 A1
(43) Pub. Date: Jun. 13, 2002

(54) Method of implementing optical data transmission of mobile station, data transmission element and mobile station stand

(76) Inventors: Duncan Burns, Dallas, TX (US); Petteri Liikanen, Poway, CA (US); Robert Shepherd, Calabasas, CA (US); Guy Nicholson, Singapore (SG)

Correspondence Address: PERMAN & GREEN, 425 POST ROAD, FAIRFIELD, CT, 06430, US

(21) Appl. No.: 09/880,369

(22) Filed: Jun. 13, 2001

(30) Foreign Application Priority Data
Jun. 16, 2000 (FI) 20001443

(51) Int. Cl. H04B 10/00

(52) U.S. Cl. 359/172; 359/154

(57) ABSTRACT

A method, data transmission element and stand for enabling optical data transmission in a mobile station. A mobile station, which comprises means for transmitting and/or receiving data in optical format, is arranged in a stand which comprises a data transmission element. The data transmission element transmits the optical signals transmitted by the mobile station to the surrounding area of the stand and/or the optical signals intended for the mobile station from the surrounding area of the stand to the mobile station. The optical signal propagates through the data transmission element in optical format and can be infra-red light, visible light and/or ultra-violet light.

### BACKGROUND OF THE INVENTION

1. Field of the Invention

The invention relates to a method of implementing optical data transmission in a mobile station, in which method the mobile station, which comprises means for transmitting and/or receiving data in optical format, is arranged in a mobile station stand which stand comprises at least one data transmission element which receives optical signals transmitted by the mobile station and/or transmits optical signals intended for the mobile station to the mobile station.

The invention further relates to a data transmission element which is arranged to receive optical signals transmitted by an optical transmitter of the mobile station and/or to transmit optical signals to an optical receiver of the mobile station in question.

The invention also relates to a mobile station stand which comprises a space and attaching elements for attaching the mobile station detachably to the stand and at least one data transmission element which is arranged to receive optical signals transmitted by the optical transmitter of the mobile station arranged in the stand and/or to transmit optical signals to the optical receiver of the mobile station in question.

The invention is associated with wireless mobile stations, such as mobile phones, communicators and the like. The invention is in particular associated with mobile stations which also include means for wireless transmission of data by optical means between the mobile station and a second apparatus in its vicinity and capable of optical data transmission, such as a PC, printer, facsimile, camera or the like. Optical data transmission in mobile stations usually takes place on infra-red (IR) wave lengths, but other wave lengths, such as visible light or ultra-violet (UV) light, can also be used in the optical data transmission in question.

2. Brief Description of Related Developments

Arranging mobile station components in the smallest possible space and/or in an economical manner dictates the location of the transmitter and receiver for optical data transmission. In some mobile stations, the transmitter and receiver for optical data transmission have had to be arranged in such a manner that they are obscured when the mobile station is placed in a desk or car stand or the like. This prevents optical communication, because optical data transmission requires an obstacle-less air link between the sending and the receiving unit. For instance, in the Nokia 9110 communicator, the transmitter and the receiver for optical data transmission are located beside the recharging connector, in other words, at the end of the communicator which is arranged in the stand, which follows that optical data transmission cannot be used when the communicator is in the stand. On the other hand, in designing a stand, factors relating to its basic function are more important than the location of the transmitter and receiver for optical data transmission.

Publication U.S. Pat. No. 5,640,155 discloses a solution for utilizing the optical data transmission feature of an apparatus arranged in a stand. The publication describes a stand and a measuring device arranged detachably to it, such as a multimeter, which communicates wirelessly with the stand when arranged in the stand on IR, UV or VIS wave lengths, for instance. The stand is connected to other devices with a cable which in some cases restricts and complicates the use of the solution.

It is an object of the present invention to provide a simple and reliable solution for enabling optical data transmission in a mobile station arranged in its stand.

### SUMMARY OF THE INVENTION

The method of the invention for enabling optical data transmission in a mobile station is characterized in that the optical signals transmitted by the optical transmitter of the mobile station are transmitted in optical format through the data transmission element to the surrounding area of the stand and/or the optical signals from the surrounding area and intended for the mobile station are transmitted in optical format through the data transmission element to the optical receiver of the mobile station

Further, the data transmission element of the invention is characterized in that the optical signals transmitted by the optical transmitter of the mobile station and/or those intended for the optical receiver of the mobile station are arranged to propagate in optical format through the data transmission element.

The mobile station stand of the invention is characterized in that the optical signals transmitted by the mobile station are arranged to pass in optical format through the data transmission element and still as an optical signal to the surrounding area of the stand and/or the optical signals received from the surrounding area of the stand to the data transmission element are arranged to pass in optical format through the data transmission element to the optical receiver of the mobile station.

The essential idea of the invention is that at least one optical data transmission element is arranged in the mobile station stand, through which the optical data transmission of the mobile station takes place in such a manner that the optical signals transmitted by the mobile station and the optical signals intended for the mobile station propagate as optical signals through said optical data transmission element. It should be noted that in the following, this application refers to a mobile station as a station and to an optical data transmission element as a data transmission element. Further, the essential idea of a preferred embodiment of the invention is that the optical signal is infra-red light. Further, the essential idea of a second preferred embodiment of the invention is that the optical parts of the data transmission element are made of plastic, preferably polycarbonate Further, the essential idea of a third preferred embodiment of the invention is that the stand comprises two data transmission elements, one for optical signals from the station and one for optical signals to the station.

The invention provides the advantage that a station arranged in a stand can communicate optically with apparatuses capable of optical data transmission in the surrounding area The communication of the station is done without any relatively expensive and complex processors, amplifiers or other active optical components arranged in the stand. Wireless data transmission based on infra-red light is easy, its power consumption is low and the components are inexpensive. The raw material and manufacturing costs of a data transmission element made of plastic are low, its structure is simple, non-wearing and reliable By reserving a separate data transmission element for both outgoing and incoming optical signals makes it possible to dimension and design the elements optimally for their task

### BRIEF DESCRIPTION OF THE DRAWINGS

The invention is described in greater detail in the attached drawings in which

FIG. 1 shows a cross-sectional schematic of an embodiment of a mobile station stand of the invention from the front,

FIG. 2 shows a cross-sectional schematic of a part of a second embodiment of a mobile station stand of the invention from the front,

FIG. 3a shows a cross-sectional schematic of a third embodiment of a mobile station stand of the invention from the side, and

FIG. 3b shows a schematic of a part of the embodiment of the mobile station stand shown in FIG. 3a from the front.

### DETAILED DESCRIPTION OF PREFERRED EMBODIMENT(S)

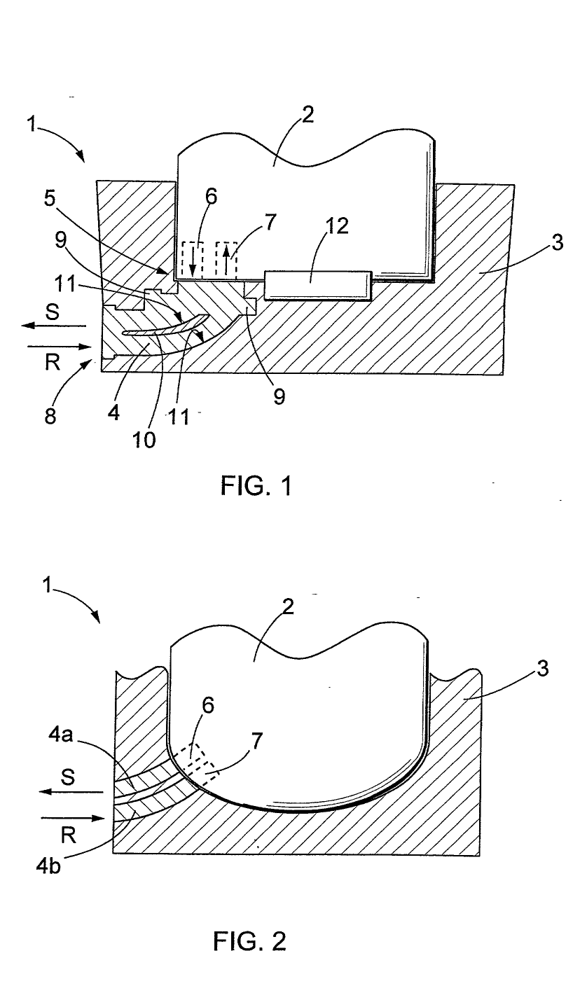

FIG. 1 shows a cross-sectional schematic of an embodiment of a mobile station stand of the invention from the front. A mobile station 2 shown only partly in the figure is arranged in a space made in the stand 1. The stand 1 comprises a stand body 3, a data transmission element 4 and connectors 10. It should be noted that the stand body 3 is shown in FIGS. 1 to 3b in a greatly simplified manner: the body 3 is usually made up of cover parts joined together, and various components and elements are arranged to it, which are not shown in the figures to simplify the presentation of the matter. The stand 1 is for instance a desk stand intended to be placed on a table or a corresponding platform, a car stand intended to be fixed in a vehicle, or any other stand known per se, to which the mobile station can be detachably attached.

The mobile station 2 has means for optical data transmission, which means and the application of optical data transmission are well known per se to a person skilled in the art and they are, therefore, not described in this application in more detail. The means comprise an optical transmitter 6 which transmits the optical signals of the station from the station 2, and an optical receiver 7 which receives optical signals intended for the station 2. In this application, optical data transmission refers to data transmission on infra-red wave lengths (IR), on visible light wave lengths (VIS) and on ultra-violet wave lengths (UV) or on a combination of them.

A data transmission element 4 is arranged in the stand body 3, its first end 5 arranged at the optical transmitter 6 and the optical receiver 7 of the station 2 placed in the stand 1 and its second end 8 faces towards the outside of the stand 1. In the embodiment shown in FIG. 1, the data transmission element 4 is fixed with mounting brackets 9 to the stand body 3, but it can also be fixed with other means, such as by crimping or gluing or by any other means known per se.

The data transmission element 4 is made of an optically permeable material, more exactly of a material which allows the penetration of the wave length used in the optical data transmission in question. Suitable materials are for instance plastic, glass or other corresponding permeable materials which do not easily scratch and which can preferably be colored with suitable coloring agents or pigments. A data transmission element 4 for data transmission in the IR area, for instance, can be made of polycarbonate (PC), preferably of the grade developed for IR data transmission, or of polymethyl-methacrylate (PMMA). Advantages of a data transmission element 4 made of plastic include low raw material costs, manufacturing methods with low unit cost, such as injection-molding, and low weight. A data transmission element 4 made of glass, for instance quartz glass, provides the advantage that it is extremely permeable, which allows for a lower transmission power or a longer operational range of data transmission. Naturally, the data transmission element 4 can comprise several parts which have been made of different materials.

An optical signal S transmitted by the optical transmitter 6 of the station 2 goes in to the data transmission element 4 through the first end 5. The signal propagates inside the data transmission element 4 according to optical laws reflecting from the reflecting surfaces 11 of the data transmission element 4. In the embodiment shown in the figure, the data transmission element 4 is shaped so that the signal is reflected from the reflecting surface 11 of a divider 10 in the element 4 to the second end 8 of the element 4 and onwards outside the stand 1. With the optical design of the data transmission element 4, it is possible to affect the direction of the outgoing signal S. With a narrow transmission cone, the signal can be transmitted more reliably and with a lower power consumption to the receiver; on the other hand, by widening the transmission cone, the signal becomes less dependent on the stand position in relation to the receiver, whereby the stand can be positioned more freely. A signal scattering into the surrounding area in the shape of a hemisphere makes it possible to position the stand 3 and the receiving apparatus very freely

An optical signal R intended for the station 2 goes in to the data transmission element 4 through its second end 8 from which it propagates inside the data transmission element 4 reflecting from the reflecting surfaces 11 of the data transmission element 4 to the first end 5 and onwards through it to the optical receiver 7 of the station 2. The surface quality of the data transmission element 4 ends 5 and 8 and that of the reflecting surfaces 11 must be as smooth as possible, for instance polished, so as to make the scattering and the fading of the signals caused by it as small as possible.

An optical divider 10 is formed in the data transmission element 4, which separates the routes of the transmission signal S and the incoming signal R from each other. The optical divider 10 prevents the signals S and R from mixing which in some situations might disrupt optical data transmission. Naturally, it is possible to apply two separate data transmission elements 4 one for the transmission signals S and one for the incoming signals R.

FIG. 2 shows a cross-sectional schematic of a part of a second embodiment of a mobile station stand of the invention from the front. It should be noted that the reference numbers of the figures correspond to each other. FIG. 1 has two data transmission elements arranged to it, namely a first data transmission element 4a for transmitting optical signals going out from the mobile station 2 to the surrounding area and a second data transmission element 4b for transmitting optical signals intended for the mobile station 2 from the surrounding area to the station 2. The data transmission elements 4a, 4b are fiber-like in shape. Their index of refraction changes gradually from the center point of the data transmission element 4a, 4b towards the outside in such a manner that an optical signal which goes outwards in cross-section of the element bends slowly back to the center of the element. The principle of the data transmission element 4a, 4b is similar to that of a graded index fiber and is thus known per se to a person skilled in the art. The data transmission element 4a, 4b can also be made of other optical fibers known per se.

When using separate data transmission elements 4a, 4b, the optical properties of the first data transmission element 4a can be optimized so that optical data transmission of the station 2 is reliable and yet receivable in a wide area. Separate data transmission elements should preferably be applied to stations 2 whose optical transmitters and receivers are arranged not quite beside each other. Naturally, the optics of the separate data transmission elements 4a, 4b can also be based on reflecting surfaces, as in the embodiment shown in FIG. 1. In an embodiment, the stand comprises a data transmission element 4a, 4b only for receiving optical signals and in another embodiment only for transmitting optical signals.

In addition to being a desk or car stand or the like, the stand 1 can also be a casing surrounding substantially completely the station 2 and protecting it from external stress, for instance, or being aesthetically advantageous, for instance. In this application, the stand 1 refers generally to a structure which is designed so that the station 2 can be arranged in it. The stand 1 can naturally comprise elements not shown in FIGS. 1 to 3b: for instance means for attaching the stand to the dashboard of a car or a similar location, components and means required for charging the battery of the station 2, weights for lowering the center of gravity of a desk stand.

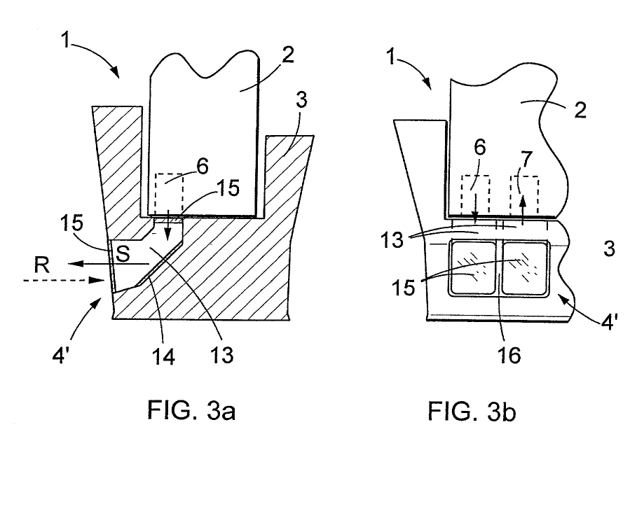

FIG. 3a shows a cross-sectional schematic of a third embodiment of a mobile station stand of the invention from the side and FIG. 3b shows a schematic of the embodiment of the mobile station stand shown in FIG. 3a from the front The data transmission element 4′ comprises two channels 13 on the inside surface of which reflectors 14 are arranged Signals S transmitted by the optical transmitter 6 of the station 2 reflect from the reflector 14 out of the stand 1 and correspondingly, optical signals coming in to the data transmission element 4′ reflect from the reflector 14 to the optical receiver 7 of the station. The data transmission element 4′ can naturally comprise more than one reflector 14. The channel ends are closed with lids 15 which allow the penetration of the used optical wave length, the lids preventing impurities, humidity or corresponding harmful elements from entering the data transmission element 4′. The channels 13 are separated from each other with a wall 16 which prevents the outgoing and incoming signals S and R from mixing. One embodiment does not use two separate channels 13, but one and the same channel 13 transmits both outgoing and incoming optical signals S and R In such a case, the possible data transmission disturbances caused by the mixing of the signals S and R are prevented by signal processing, for instance.

The drawings and the related description are only intended to illustrate the idea of the invention. The invention may vary in detail within the scope of the claims. Thus, the number of data transmission elements 4, 4a, 4b, 4′ arranged in the stand may be more than two. The data transmission elements 4, 4a, 4b, 4′ can be directed in different directions of the stand 1, whereby the optical communication of the station 2 arranged in the stand 1 is possible in a substantially wider area.

What is claimed is:

1. A method of implementing a optical data transmission of a mobile station, in which method the mobile station, which comprises means for transmitting and/or receiving data in optical format, is arranged in a mobile station stand which stand comprises at least one data transmission element which receives optical signals transmitted by the mobile station and/or transmits to the mobile station optical signals intended for the mobile station, wherein the optical signals transmitted by the mobile station are transmitted in optical format through the data transmission element and on to an area surrounding the stand wherein the optical signals coming from the surrounding area and intended for the mobile station are transmitted in optical format through the data transmission element on to an optical receiver of the mobile station.

2. A method as claimed in claim 1, wherein the optical signal comprises infra-red light

3. A method as claimed in claim 1, wherein the optical signal comprises visible light.

4. A method as claimed in claim 1, wherein the optical signal comprises ultra-violet light.

5. A data transmission element which is arranged to receive optical signals transmitted by an optical transmitter of a mobile station and to transmit optical signals to an optical receiver of the mobile station, wherein the optical signals transmitted by the optical transmitter of the mobile station and the optical signals intended for the optical receiver of the mobile station are arranged to propagate in an optical format through the data transmission element.

6. A data transmission element as claimed in claim 5, wherein the optical signal is arranged to propagate in the data transmission element mainly by refraction.

7. A data transmission element as claimed in claim 5, wherein the optical signal is arranged to propagate in the data transmission element mainly by reflection.

8. A data transmission element as claimed in claim 7, wherein at least one reflector is arranged in the data transmission element.

9. A data transmission element as claimed in claim 5, wherein the data transmission element is an optical fiber.

10. A mobile station stand which comprises a space and attaching elements for attaching a mobile station detachably to the stand, and at least one data transmission element which is arranged to receive optical signals transmitted by an optical transmitter of the mobile station arranged in the stand and to transmit optical signals to an optical receiver of the mobile station, wherein the optical signals transmitted by the mobile station are arranged to pass in an optical format through the data transmission element and still as an optical signal to a surrounding area of the stand wherein optical signals received from the surrounding area of the stand to the data transmission element are arranged to pass in optical format through the data transmission element to the optical receiver of the mobile station.

11. A mobile station stand as claimed in claim 10, wherein the optical signal is arranged to propagate in the data transmission element mainly by refraction.

12. A mobile station stand as claimed in claim 10, wherein the optical signal is arranged to propagate in the data transmission element mainly by reflection.

13. A mobile station stand as claimed in claim 12, wherein at least one reflector is arranged in the data transmission element.

14. A mobile station stand as claimed in claim 10, wherein the data transmission element is an optical fiber.

15. A mobile station stand as claimed in claim 10, wherein the stand is a desk stand.

16. A mobile station stand as claimed in claim 10, wherein the stand is a car stand.

17. A mobile station stand as claimed in claim 10, wherein the stand is an installation stand.

18. A mobile station stand as claimed in claim 10, wherein the stand is a protective casing.

19. A mobile station stand as claimed in claim 10, wherein charging means for charging the battery of the mobile station are arranged in the stand.

20. A mobile station stand as claimed in claim 10, wherein the stand comprises two data transmission elements, one for optical signals going out from the mobile station and one for optical signals coming in to the mobile station
